(19) United States
(12) Patent Application Publication
(10) Pub. No.: US 2013/0328689 A1
(43) Pub. Date: Dec. 12, 2013

(54) MEDIUM PROCESSOR NOTIFYING WHEN SERVICING IS REQUIRED

(71) Applicant: Oki Electric Industry Co., Ltd., Tokyo (JP)

(72) Inventor: Tomonori HAYASHI, Tokyo (JP)

(73) Assignee: OKI ELECTRIC INDUSTRY CO., LTD., Tokyo (JP)

(21) Appl. No.: 13/903,836

(22) Filed: May 28, 2013

(30) Foreign Application Priority Data
Jun. 11, 2012 (JP) 2012-131774

(51) Int. Cl. G08B 5/22

(52) U.S. Cl. CPC G08B 5/22
USPC 340/691.6

(57) ABSTRACT

A medium processor for processing a medium has a path for transporting the medium; a display for displaying a processing status of the medium; a sensor for sensing the medium on the path, the sensor including a light-emitting device for emitting light and a photosensitive device for receiving the light; and a controller for controlling the operation of the processor. The controller has a light amount detector for detecting the amount of the light the photosensitive device receives; a comparator for comparing the amount of the light with a predetermined reference value; a light amount adjuster for adjusting the amount of electric power to adjust the amount of electric power in steps; a cleaning determiner for determining that the sensor needs to be serviced under a certain condition; and a display controller for controlling the display to display an indication of the sensor to be serviced.

### BACKGROUND OF THE INVENTION

1. Field of the Invention

The present invention relates to a medium processor, in particular a cash processor which may be installed in cash registers for use in shops such as convenience stores and supermarkets.

2. Description of the Background Art

A type of cash processors conventionally installed in cash registers may be a change dispenser, which may be connected in use to a point of sale (POS) register. For example, Japanese patent laid-open publication No. 2010-152436 to Suzuki teaches a machine for accepting a plurality of bills and coins and delivering cash as change.

By the way, a transmission-type of optical sensors is conventionally known, the sensor including a light-emitting device such as a light-emitting diode (LED) and a photosensitive device such as a phototransistor or a photodiode. The transmission-type optical sensor is designed such that the light-emitting device emits light and the photosensitive device receives the light transmitted through an object to be sensed staying between both devices to sense a pattern of the transmitted light on the basis of the intensity of the latter. Especially, Japanese patent laid-open publication No. 2011-59077 to Miyashita teaches an optical sensor having a light-emitting device and a photosensitive device wherein the output characteristics of the devices can be adjusted according to the sensitivity of the optical sensor even when the devices are tainted or their output characteristics vary across the age.

However, in general, the conventional art such as Miyashita does not have any sufficient means for coping with situations where the automatic adjustment of the characteristics cannot be satisfactory. Especially, in recent years, cash processors have been installed in various shops such as convenience stores and gas stations. In such shops, the cash processors may be manipulated by a clerk who has relatively little experience and knowledge on mechanical servicing of the cash processors. Furthermore, in those installation sites, if the processor malfunctions, it has to be instantly repaired at any time of day or night.

In addition, the cash processor does not generally include any means of producing a notice as to whether servicing is required during operation. It is therefore generally uncertain which portion has to be mended and whether the processor has successfully resumed its normal condition after serviced. In addition, operators or servicemen may deal differently person by person, thus problematically causing the processor to be ceased for a long time.

### SUMMARY OF THE INVENTION

It is therefore an object of the present invention to provide a medium processor which can inspect itself at least at startup in its initialization step to produce, if an abnormality is found, a notice of the abnormality and locate a defect and/or display the level of the failure.

It is another object of the invention to provide a medium processor which can suggest, or produce a notice of, a possibility that the processor will be required to be serviced in the near future even when the processor determines that immediate servicing is not needed.

In accordance with the present invention, a medium processor for processing a medium comprises a path transporting the medium to be processed in the medium processor; a display displaying a processing status of the medium; a sensor sensing the medium on the path and including a light-emitting device emitting light and a photosensitive device receiving the light emitted by the light-emitting device to produce a signal associated with the light received; and a controller controlling the operation of the medium processor to determine whether or not the medium is present on the path. The controller comprises a light amount detector detecting from the signal the amount of the light that the photosensitive device receives upon startup of the medium processor; a comparator comparing the amount of the light detected by the light amount detector with a predetermined reference value; a light amount adjuster adjusting the amount of electric power to be supplied to the light-emitting device to adjust, when the comparator determines that the amount of the light is outside a tolerable range with respect to the predetermined reference value, the amount of electric power preferably in steps below the maximum rated value of the light-emitting device; a cleaning determiner determining that the sensor needs to be serviced when the amount of electric power supplied to the light-emitting device is close to the maximum rated value under a condition where the amount of the light received by the photosensitive device is within the tolerable range of the reference value; and a display controller controlling the display so that an indication of the need to service the sensor is displayed on the display when the cleaning determiner determines that the sensor needs to be serviced.

In accordance with the present invention, the amount of light emitted by the sensor can be automatically checked and adjusted at the startup of the processor. Only when servicing is needed, a notice of the necessity of the servicing is produced. Unless the processor thus serviced issues a request for servicing when restarted, the operator may understand the servicing is successful. Thus, the medium processor is extensively improved in convenience in use for the operator. The medium processor in accordance with the invention is further advantageous in that even a rather novice operator can easily manipulate the processor.

### BRIEF DESCRIPTION OF THE DRAWINGS

The objects and features of the present invention will become more apparent from consideration of the following detailed description taken in conjunction with the accompanying drawings in which:

FIG. 1 is a schematic control block diagram of a media processor in accordance with an embodiment of the present invention;

FIG. 2 is a perspective view of the medium processor shown in FIG. 1;

FIG. 3 is a schematic block diagram of the bill processor shown in FIG. 1;

FIG. 4 is a schematic view of an embodiment of the optical sensor included in the medium processor shown in FIG. 3;

FIG. 5 is a schematic view of another embodiment of the optical sensor shown in FIG. 3;

FIG. 6 is a plane view of the display screen of the display, shown in FIG. 1, on which maintenance indication information is displayed;

FIG. 7 is a functional block diagram of the controller shown in FIG. 1;

FIG. 8 shows a table illustrating a relationship between the light emission level of the sensor and the indications of the status indicator shown in FIG. 6;

FIG. 9 is a flowchart useful for understanding the operation for adjusting the light emission level of the sensor of the bill processor shown in FIG. 1;

FIGS. 10-12 show tables illustrating other relationships between the light emission level of the sensor and the indications of the status indicator shown in FIG. 6;

FIG. 13 shows a table illustrating a relationship between the light emission level of the sensor and sound emitted by the loudspeaker shown in FIG. 1;

FIG. 14 is a functional block diagram of an alternative embodiment of the controller shown in FIG. 1; and

FIG. 15 is a flowchart useful for understanding the operation of the medium processor including the controller shown in FIG. 14.

### DESCRIPTION OF THE PREFERRED EMBODIMENTS

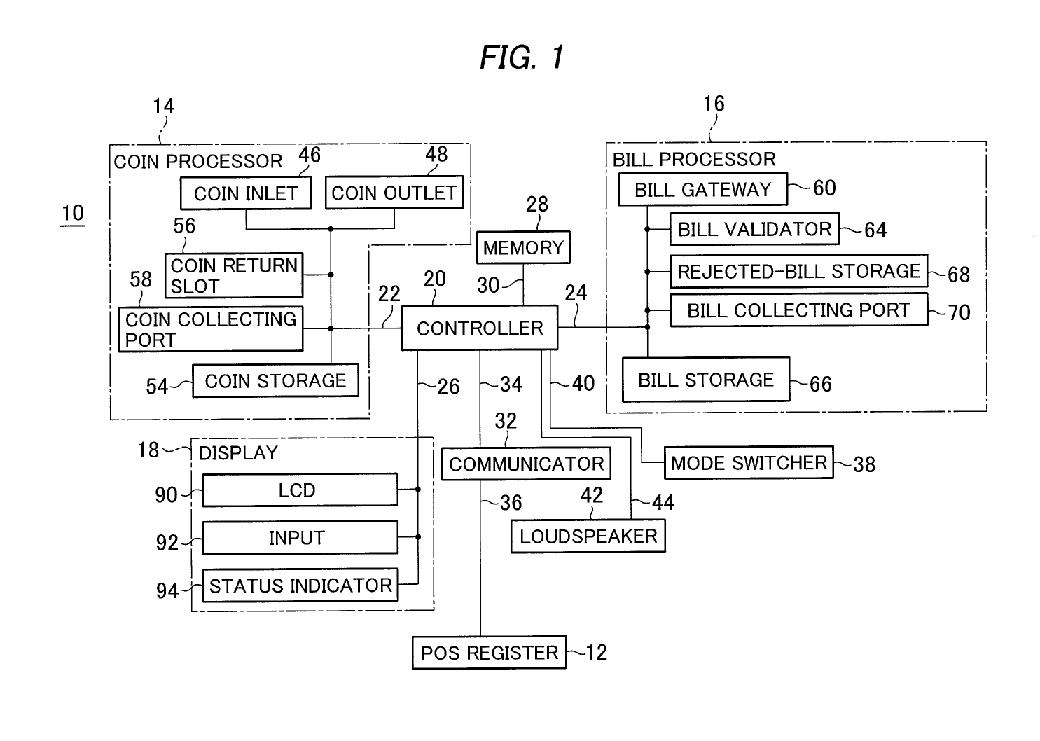

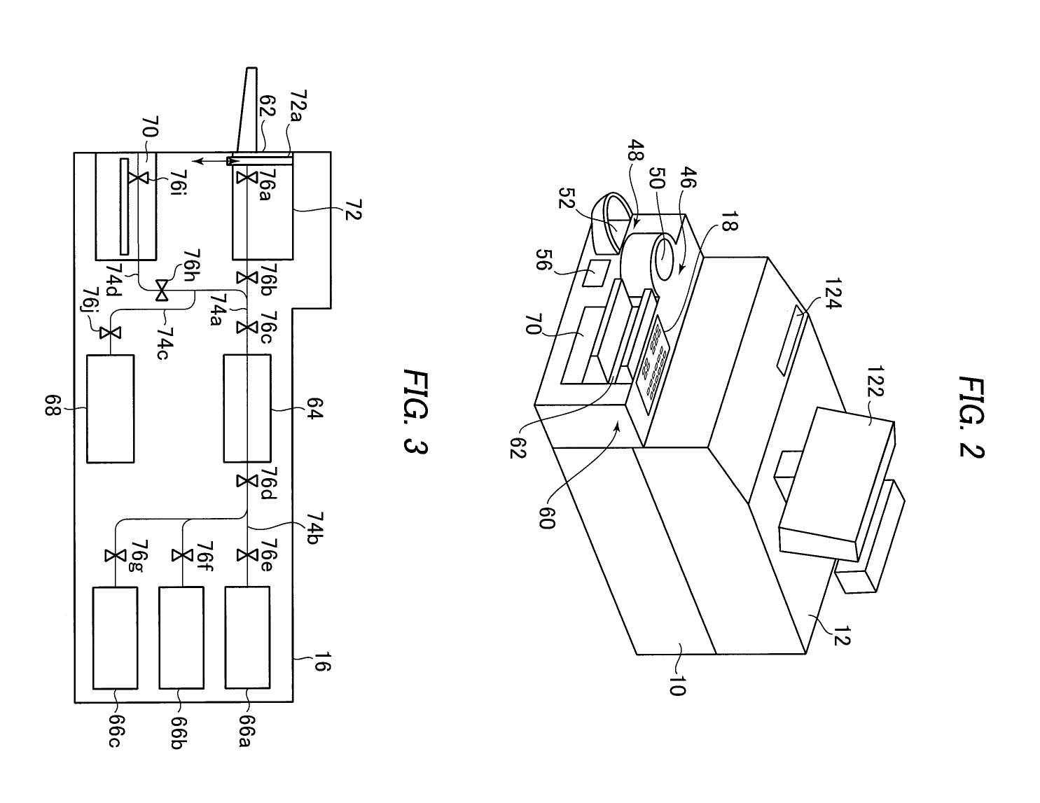

With reference to the accompanying drawings, a preferred embodiment of the present invention will be described. FIGS. 1 and 2 show a media processor, more specifically a cash processor, 10 for processing media such as bills and coins in accordance with a preferred embodiment of the invention. The cash processor 10 may be installed in a store such as supermarket or convenience store in conjunction with a POS (point-of-sale) register 12 to receive and deliver coins and bills. The cash processor 10 includes a coin processor 14 for processing coins, a bill processor 16 for processing bills, and a display unit 18 for displaying how media such as bills and coins are being processed in the cash processor 10.

The cash processor 10 also includes a controller 20 for controlling the coin processor 14, the bill processor 16 and the display unit 18. The controller 20 is connected to the coin processor 14, the bill processor 16 and the display unit 18 by communication lines 22, 24 and 26, respectively. The controller 20 controls the components of the cash processor 10 according to control programs stored in a memory 28, which is connected to the controller 20 by a communication line 30.

The cash processor 10 further includes a communicator 32 for communicating with the POS register 12 which manages deposition and withdrawal of paper currencies and coins. The communicator 32 is controlled by the controller 20 via a communication line 34. The communicator 32 in the cash processor 10 is connected by a communication line 36 to the POS register 12 to communicate with each other.

The cash processor 10 also includes a mode switcher 38 for switching operational modes of the cash processor 10 between a normal operation mode and a sensor cleaning mode. The mode switcher 38 is controlled by the controller 20 via a communication line 40. The memory 28 is adapted to store control programs operable for those modes.

The cash processor 1 can include a loudspeaker 42 for audibly informing the user of the conditions of the cash processor 10. The loudspeaker 42 is controlled by the controller 20 via a communication line 44. Under the control by the controller 20, the loudspeaker 42 can warn the need of servicing of the bill processor 16 to the user.

Next, the constitutional elements of the cash processor 10 will be described in detail. The coin processor 14 has a coin inlet section 46 for receiving coins entered by the customer and a coin outlet section 48 for delivering coins as change to the customer. The coin inlet section 46 has a coin inlet slot 50. The coin outlet section 48 has a coin delivery port 52.

The coin processor 14 has a coin storage 54 for storing coins according to the denominations thereof. When coins to be deposited are thrown into the coin inlet slot 50, they are conveyed to the coin inlet section 46, where their denominations are determined to sort the coins according to the denominations. The sorted coins are further conveyed to the coin storage 54 and stored thereinto. When change is needed to be delivered as coins, coins stored in the coin storage 54 are conveyed to the coin delivery port 52 of the coin outlet section 48.

The coin processor 14 also has a coin return slot 56 for returning rejected coins. Whenever a coin inserted on the coin inlet slot 50 cannot be determined by the coin inlet section 46 as any of the legitimate denominations of coins, that coin will be returned on the coin return slot 56.

The coin processor 14 further has a coin collecting port 58 for allowing the user such as a store manager to take out coins stored in the coin storage 54 when he or she collect the stored coins. The coin delivery port 52 may act also as the coin collecting port 58, depending on the amount of coins to be collected at a time.

The above-described elements of the coin processor 14 may be connected by coin transport paths, not shown, to convey coins when the coin processor 14 operates to receive and deliver coins.

The bill processor 16 includes a bill gateway 60 for receiving bills from the user to deposit the bills and delivering bills as change to the user. As shown in FIG. 2, the bill gateway 60 can be placed beside the coin processor 14. The bill gateway 60 has a bill slot 62 which is an opening where bills are taken in and out. The bill slot 62 acts as a bill insertion port from which deposited bills are received and also as a bill delivery port from which bills are discharged to be delivered as change to the customer.

The bill processor 16 includes a bill validator 64 for determining the denominations and validity, i.e. genuine or bogus, of bills inserted on the bill slot 62.

The bill processor 16 includes a bill storage 66 for storing bills according to denominations. The bill processor 16 also includes a rejected-bill storage 68 for storing rejected bills. Whenever the bill validator 64 determines that an inserted bill is defective, the rejected-bill storage 68 will store the rejected bill therein.

The bill processor 16 includes a bill collecting port 70. When bills stored in the bill storage 66 need be collected by the user such as a store manager or when a bill is determined bogus by the bill validator 64, those bills are conveyed into the bill collecting port 70 to be returned to the user.

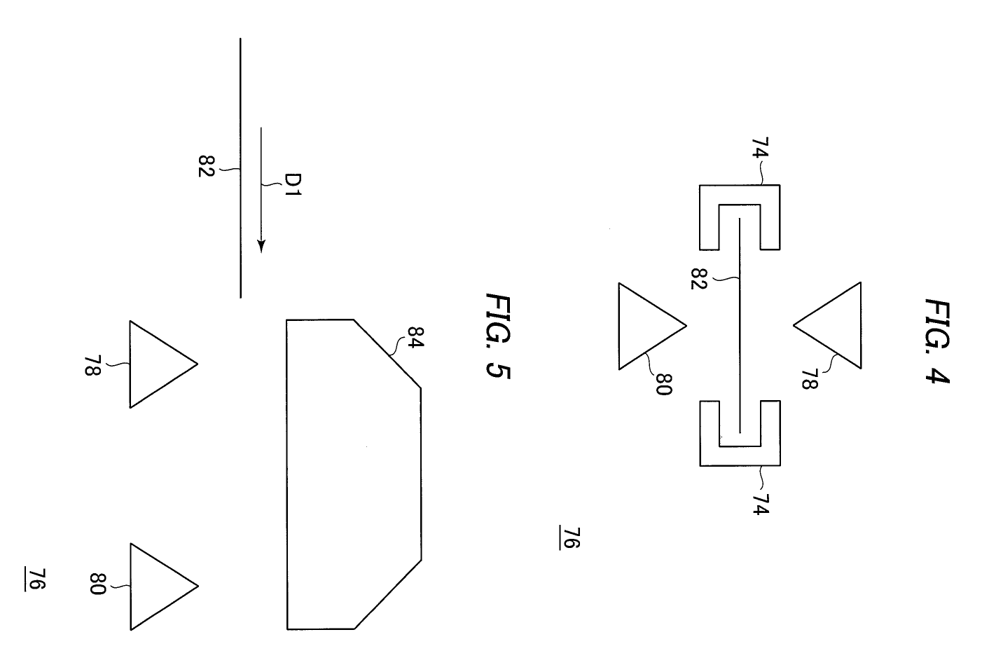

FIG. 3 depicts, in a schematic cross-sectional side view, the internal configuration of the bill processor 16 in the cash processor 10 of the instant embodiment. The front side of the cash processor 1 corresponds to the left side of the figure. On the front side of the cash processor 1, the bill slot 62 is arranged in the bill processor 16. As seen from the figure, the back side of the bill slot 62 is connected with a bill acceptor 72 for receiving bills inserted on the bill slot 62. The bill acceptor 72 has a shutter 72a for opening and closing the entrance of the bill acceptor 72.

The bill processor 16 includes at least one path 74 for transporting bills to be processed in the processor 16 between the acceptor 72, the bill validator 64, the bill storage 66, the rejected-bill storage 68 and the bill collecting port 70. The path 74 is formed between pairs of guide members, not shown, for regulating in position the front and rear surfaces of each bill to guide the bill to prevent the bill from jamming. The respective guide members have transport rollers such as friction rollers and strip-like friction belts. The transport rollers partly protrude from the guide member. The front and rear surfaces of bills are held by the opposite transport rollers arranged on the pair of guide members. The rotational motion of the transport rollers is controlled to transport held bills along the transport rollers.

The path 74 has a branching point where a rotatable blade, not shown, is mounted for switching the transport route of bills. The destination of bills may be selected by controllably switching the blades and rotating the transport rollers.

As shown in FIG. 3, the bill acceptor 72 has its rear side connected to the bill validator 64 by a transport path 74a. The rear side of the bill validator 64 is further connected to the bill storage 66 by a transport path 74b. The rejected-bill storage 68 and bill collecting port 70 are also connected to the elements of the bill processor 16 by the transport paths 74c and 74d, respectively.

Also shown in the figure, the bill storage 66 can be divided into reception sections 66a, 66b and 66c for storing bills denomination by denomination. For example, the reception sections 66a, 66b and 66c may receive one-dollar bills, five-dollar bills and 20-dollar bills, respectively. Of course, a desired number of reception sections may be arranged.

Bills inserted into the bill slot 62 are received by the bill acceptor 72 and passed through the bill validator 64, where they are determined with respect to denominations and validity, i.e. genuine or bogus. Bills determined as genuine notes are classified according to the denominations and then stored into appropriate one of the bill storages 66a, 66b and 66c.

The bill processor 16 includes optical sensors 76a-76j arranged along the transport path 74 for sensing the presence or absence of a medium, i.e. bills in the embodiment. Each of the optical sensors 76a-76j includes a light-emitting diode (LED) 78 for radiating infrared light to a medium, or bills, and a photosensitive device 80 such as a phototransistor (PTR) 80 for receiving part of the infrared light penetrating bills. The LED 78 and the phototransistor 80 have the respective optical axes thereof arranged in the direction substantially perpendicular to the conveyance direction of bills 82 on the path 74.

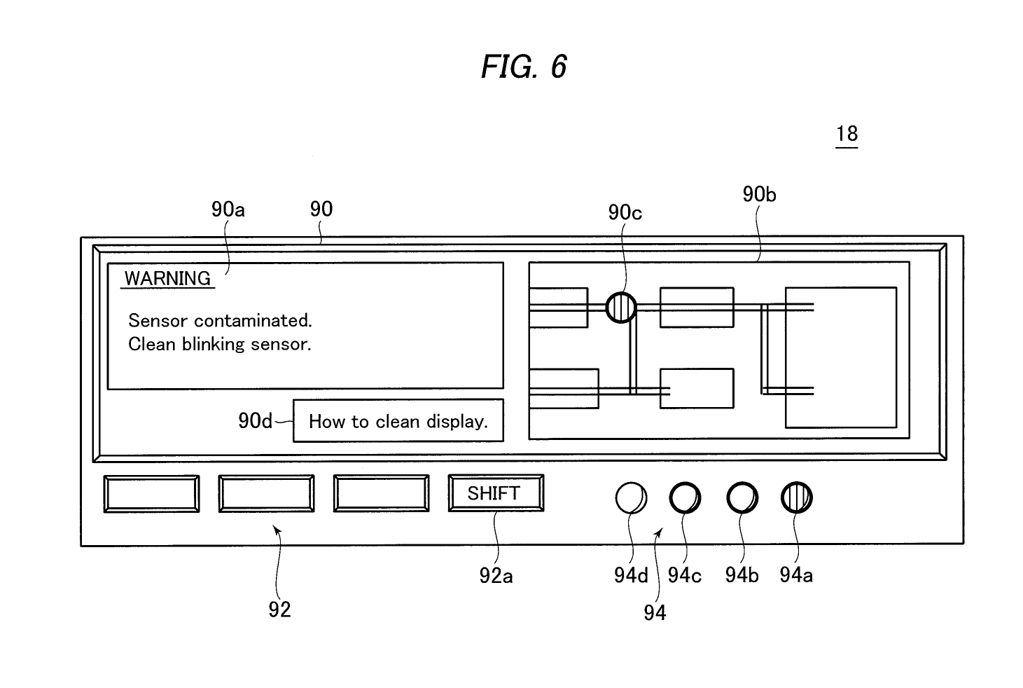

The optical sensor 76 may be designed in various configurations. In an illustrative embodiment of the optical sensor 76 shown in FIG. 4, the LED 78 and the phototransistor 80 are disposed on the respective opposite sides of the transport path 74. The axis of the LED 78 is substantially perpendicular to the path 74 and faces the axis of the phototransistor 80. Infrared light emitted by the LED 78, conceptually forming an optical axis, crosses the transport path 78 formed between the pair of guide members. The phototransistor 80 facing the LED 78 is positioned to receive the emitted infrared light.

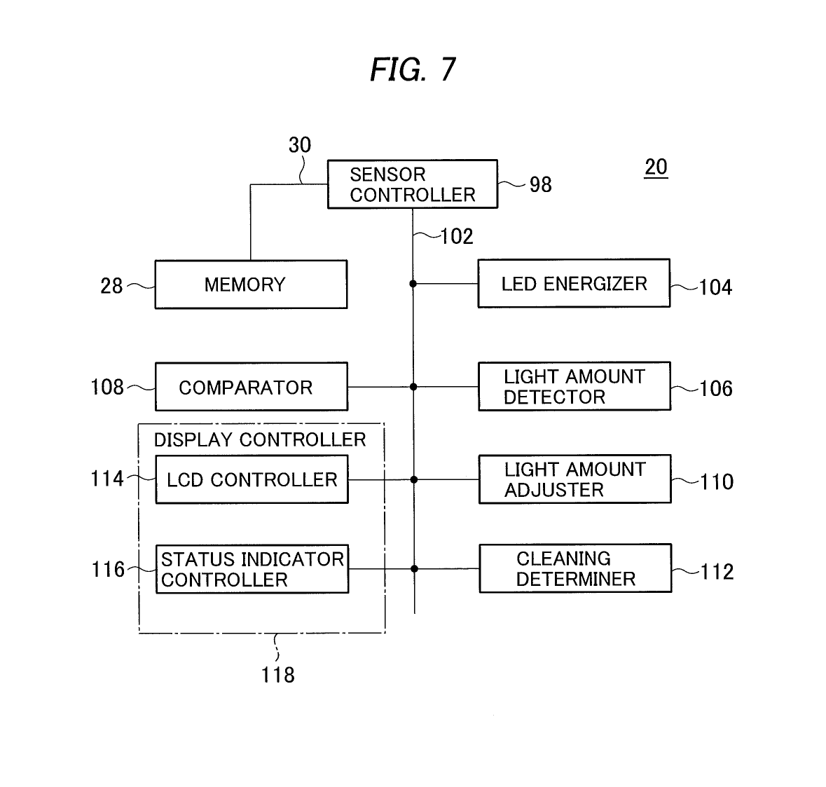

In an alternative embodiment of the optical sensor 76 shown in FIG. 5, the LED 78 and the phototransistor 80 are disposed on the same side on the transport path 74, not shown in the figure. The path 74 supports bills 82 which go in the direction of an arrow D1 in FIG. 5. The optical sensor 76 of the present alternative embodiment has a prism 84, which is disposed opposite to the LED 78 and the phototransistor 80. Infrared light emitted by the LED 78 crosses the path 74 and then enters the prism 84. The infrared light incident to the prism 84 turns in and then exits from the prism 84. The infrared light emanating from the prism 84 crosses the path 74 in the reverse direction to the previous travel to be received by the phototransistor 80. Alternatively or additionally to the above embodiments of the sensor 76, the bill processor 16 may include any types of known optical sensors.

The LED 78 is connected to a transistor or transistors, not shown, adapted for applying electrical current to the LED 78. Any known types of transistors can be applied to the present invention. The transistor or transistors is/are controlled by the controller 20, as will be described later in detail.

The above-described constitution allows the transport path 74 to regulate in position bills to guide the bills being conveyed. When a bill 82 reaches the position of the optical sensor 76, it blocks the infrared light emitted from the LED 78 of the sensor 76. Thus, the amount or intensity of light impinging on the phototransistor 78 reduces. The amount or intensity of light received by the phototransistor 78 is output to the controller 20 in the form of electric signal corresponding thereto. In the controller 20, the electric signal, which is analog, delivered from the phototransistor 78 is converted into a corresponding digital form, which will be compared with a predetermined reference value to thereby determine whether or not there is a bill on the path 74. In the illustrative embodiment, if it is determined that there is a bill on the path 74, an ON signal is produced by the controller 20, and if there is determined no bill on the path 74, an OFF signal is produced by the controller 20.

Returning now to FIG. 1, the display unit 18 comprises a display device such as a liquid crystal display (LCD) device 90, and an input unit 92 for receiving various inputs regarding replenishment of the cash processor 10 with cash and also regarding payment at the cash register. The display unit 18 further comprises a status indicator 94 for producing a visual notice representative of various processing statuses or conditions of the cash processor 10, namely, how the cash processor 10 processes. In the instant embodiment, the status indicator 94 may be made up of a set of illuminants emitting visible light, for example, a set of LEDs emitting visible light the operator can view. The constitution may cause the display unit 18 to inform the user how the cash is being processed in the cash processor 10.

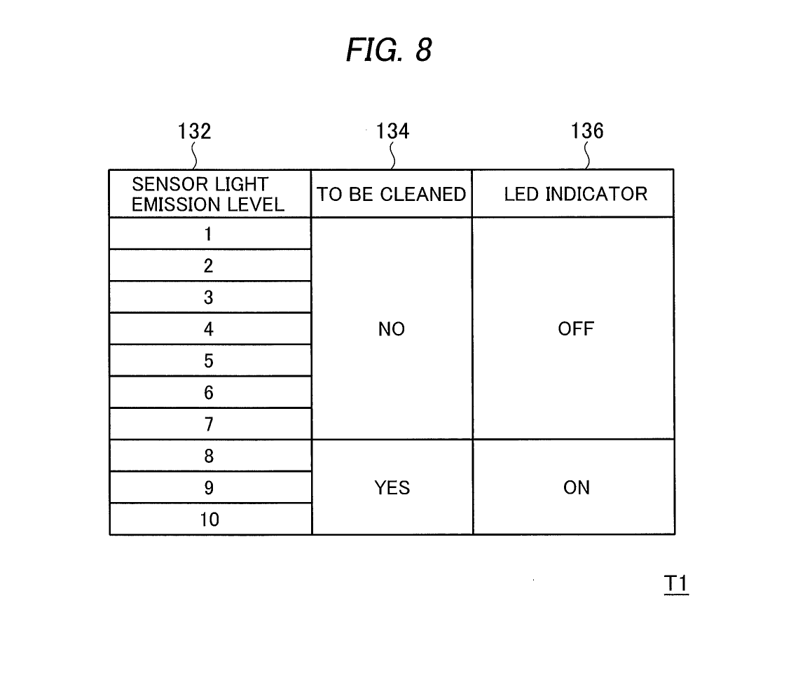

The display unit 18 will be described in more detail with reference to FIG. 6. FIG. 6 shows an example of service instruction information displayed on the display unit 18 in accordance with the embodiment. In the display unit 18, the LCD 90 displays instruction information 90a for urging the operator to clean the sensor 76, when contaminated, and positional information 90b indicating a location to be cleaned. The positional information 90b displayed on the LCD 90 may include a schematic graphical representation or view of the internal structure of the bill processor 16, such as shown in FIG. 3, for example.

On the LCD 90, a contaminated-sensor position 90c representative of a contaminated optical sensor 76, specifically 76b, FIG. 6, may be displayed by blinking, continuous lighting and so on. If at least one optical sensor 76 other than the sensor 76b is determined to be contaminated, the positional information of the contaminated optical sensor(s) other than sensor 76b can be also displayed. Of course, the optical sensor 76 to be serviced may be displayed in any other manners such as picture or icon and/or text on the display unit 18.

On the LED 90, which may be of a touch panel, an input key such as a button 90d can be displayed which may be used as a touch key for inputting an instruction for indicating a cleaning method on the display unit 18. When the button 90d is touched by the operator, detailed information on the cleaning method is read out from the memory 28 and displayed on the LCD 90.

The input unit 92 may include a shift button 92a for use in shifting the operational modes. The operator may depress the button 92a when he or she confirms a current operational situation of the cash processor 10 and/or intends to shift its operational mode. When the controller 20 receives information on the mode button 92a being depressed, the controller 20 controls the mode switcher 38 to switch the operational mode of the cash processor 10 to the other.

More specifically, when a particular input manipulation, such as depression of the mode button 92a of the input unit 92, is detected, the controller 20 determines that the sensor cleaning mode is selected. Next, the controller 20 controls the bill processor 16 so that the bill processor 16 can receive a medium for sensor cleaning inserted to convey the medium over the transport path 74 in a controlled manner. In the mean time, when the power supply is normally turned on, the prioritized mode may be the normal operation mode.

As shown in FIG. 6, the status indicator 94 may include a red LED 94a for emitting red light, an orange LED 94b for emitting orange light, a yellow LED 94c for emitting yellow light and a green LED 94d for emitting green light. With the illustrative embodiment, the status indicator 94 is designed to drive either of the LEDs 94a-94d to emit a corresponding ray, depending on the level of light amount of the sensor 76. Instead of LEDs thus arranged to generate the respective own color rays, the status indicator 94 may comprise at least one LED capable of emitting a multicolor ray.

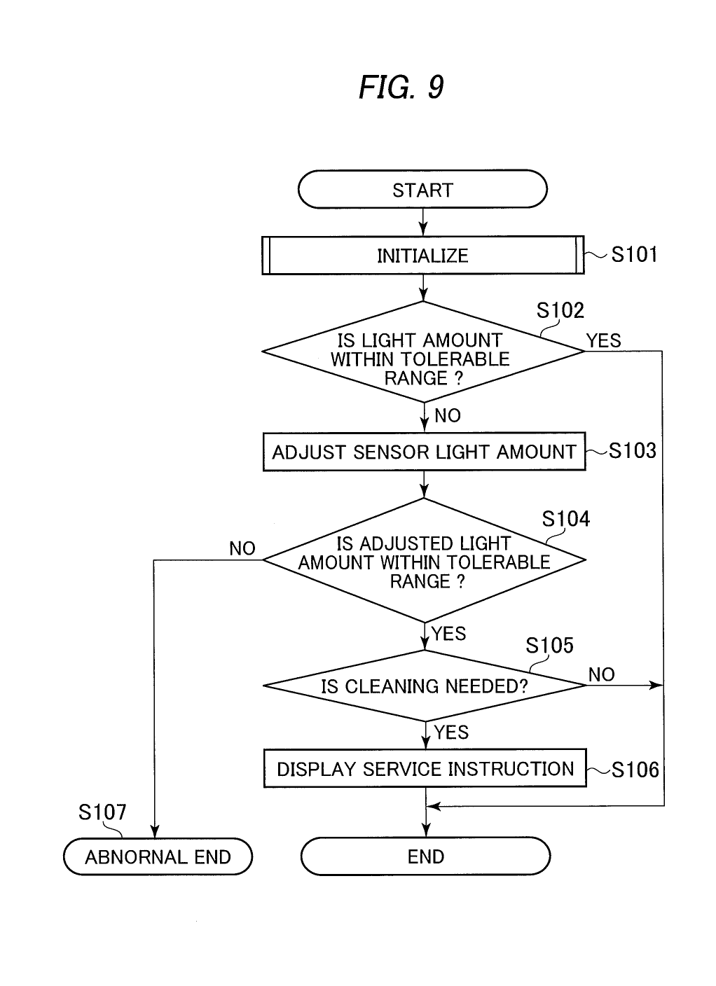

The constitution of the controller 20 will be described with reference to FIG. 7. FIG. 7 is a schematic functional block diagram of the controller 20 in the cash processor 10 in accordance with the instant illustrative embodiment. The controller 20 is connected to the memory 28 for storing control programs therein and controls the elements of the cash processor 10 in accordance with the control program stored in the memory 28 to carry out various processing operation of the cash processor 10. The memory 28 stores various setting information, image information on the servicing of the cash processor 10 and so on in addition to the control programs. The memory 28 may be included in the controller 20.

The controller 20 includes a sensor controller 98 for controlling the sensors 76a-76j. The sensor controller 98 is connected to the various control elements, described later, of the controller 20 by communication lines 102 to control the sensors in cooperation with the control elements. In a case that the memory 28 is included in the sensor controller 98, it may be connected to the controller 98 by the line 102.

The controller 20 includes an LED energizer 104 that is adapted to drive all the LEDs 78 in the optical sensors 76a-76j so as to be activated. The controller 20 further includes a light amount detector 106 for detecting the amount or intensity of light on the basis of the emitter current value of the phototransistors 80 of the sensors 76.

The controller 20 also includes a comparator 108 adapted to compare the emitter current value of the phototransistors 80 with the reference output value stored in advance in the memory 28 and then makes a decision as to whether or not the emitter current value is within a tolerable range with respect to the reference output value.

The controller 20 further includes a light amount adjuster 110 for adjusting the amount of electric power to be supplied to the LEDs 78. If the comparator 108 determines that the emitter current value is outside the tolerable range of the reference output value stored in the memory 28, the light amount adjuster 110 varies the amount of electric power to be supplied to the LEDs 78, preferably in steps, under the control of the sensor controller 98, thereby adjusting the amount or volume of light to be emitted. That is, the emitter current value of the phototransistors 80 is brought to within the tolerable range of the reference output value.

The light amount adjuster 110 may be further connected to the transistors 80, which are connected to the LEDs 78, for supplying the current to the optical sensors s76. The light amount adjuster 110 can control base currents to be supplied to the transistors 80 to adjust the light amount of the LEDs 78. Any known types of transistors can be applied to the present invention.

The controller 20 also includes a cleaning determiner 112 for determining whether or not, or when, a optical sensor 76 needs to be serviced. If the amount of electric power supplied to an LED 78 becomes closer to its maximum rated value, the cleaning determiner 112 determines that an optical sensor 76 associated therewith needs to be serviced. On the contrary, if the cleaning determiner 112 determines that the amount of electric power supplied to the LEDs 78 is still within a sufficient margin against the maximum rated value, the determiner 112 determines that no servicing is required on the optical sensors 76.

The controller 20 further includes an LCD controller 114 for controlling to display information on an instruction on servicing the sensors 76 on the LCD 90. When a sensor 76 is required to be serviced, then the LCD controller 114 instructs the LCD 90 to display information 90a on the service instruction.

The controller 20 yet further includes a status indicator controller 116 for controlling to display information on the condition of the sensors 76 on the status indicator 94. When a sensor 76 has to be serviced, the status indicator controller 116 instructs the status indicator 94 to display service instruction information. Upon the instruction from the controller 20, the sensor controller 98 controls the LCD controller 114 and the status indicator controller 116 to be operative.

The functions of the LCD controller 114 and the status indicator controller 116 may be incorporated into a display controller 118, which is adapted for generally controlling the display unit 18.

The cash processor 10 can mutually communicate with the POS register 12 to cause the register 12 to manage deposition and withdrawal of bills and coins. The POS register 12 may have a barcode reader, not shown, for reading the price of a product from a barcode attached thereto. The register 12 comprises a register display and manipulator 122, FIG. 2, including a touch panel display screen. The register display and manipulator 122 can display input keys, by means of which the customer may input the price of a product that he or she purchases, and the total price of the products he or she is purchasing.

The POS register 12 has a receipt printer 124 for issuing a receipt or statement slip on which there are printed the prices of the products the customer has purchased, the amount of bills and coins received from him or her, the change and so on.

The POS register 12 further includes a power supply, not shown, for driving the POS register 12 and the cash processor 10 associated with the register 12. The POS register 12 may be connected to a card reader, not shown, for use in accepting plastic card payment.

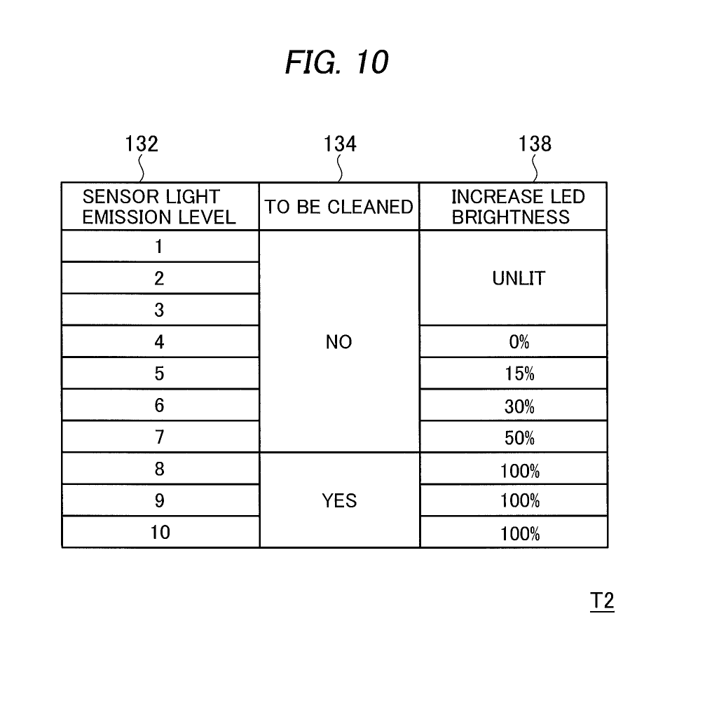

FIG. 8 shows a table T1 illustrating the relationship between the level of light amount to be emitted by the sensors 76 in the cash processor 10 of the embodiment and indications on the status indicator 94. The table T1 defines the sensor light emission level 132 of the LEDs 78, correspondingly together with the necessity of cleaning the optical sensors 76 in the column “To Be Cleaned” 134 and the condition of enabling the status indicators 94 in the column “LED Indicator” 136.

As shown on the table, the sensor light emission level 132 is classified into ten levels with the illustrative embodiment. The sensor light emission level 132 means the level of electric power to be supplied to the LEDs 78. In the table T1, the amount of light to be emitted by the LED 78 may extend between the minimum level 1 and the maximum level 10. As an example, at level 1, 75% of the maximum rated power value of the LEDs 78 is supplied. At level 10, 95% of the maximum rated power value is supplied.

In the table T1, at level 3, 80% of the maximum rated power value is set as an electric power to be supplied then, which is defined as a reference, or standard, level. This level 3 may be referred to as reference level. With illustrative embodiment, the controller 20 is set such that, when the sensor light emission level 132 is level 8 or higher, that is to say, equal to or more than 90% of the maximum rated value, a warning indicative of sensor contaminated is displayed on the LCD 90, depending on the cleaning necessity 134 of the optical sensors 76. When a sensor 76 needs to be cleaned, the status indicator 94 is also lit up, as shown in the column “LED indicator” 136 of the status indicator 94.

When the emission level 132 of an LED 78 becomes equal to or higher than 90% of the maximum rated value, the LED 78 may be used without cleaning the contaminated diode though. However, the continuous use of the LED 78 per se under this condition may adversely affect its lifetime as well as other conditions such as the directivity of the LED 78 and a temperature change across the cash processor 10. Accordingly, the levels are set such that, when the sensor light emission level 132 is close to the maximum rated value, the warning is issued to urge the service person to service, e.g. clean, the sensor 76.

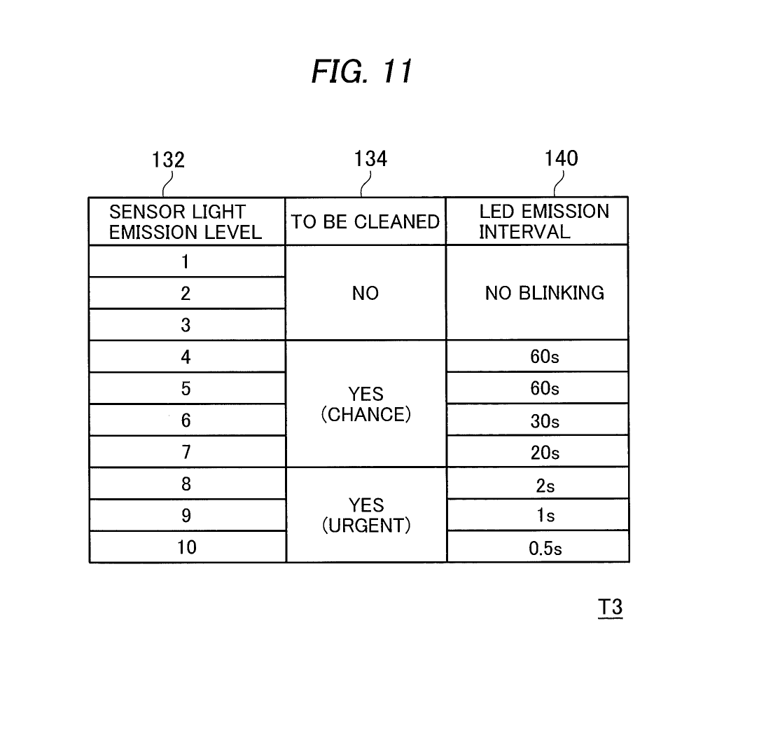

Well, it will be described with reference to the flowchart shown in FIG. 9 how the bill processor 16 adjusts the sensor light amount in the instant embodiment.

When the power supply of the cash processor 10 is turned on, the sensor controller 98 boots control programs stored in the memory 28. While the power is supplied, an instruction for resetting the cash processor 10 may be entered. In that case also, the control program is booted by the sensor controller 98 as is the case with the cash processor 10 being newly started. When the cash processor 10 is started, the control program on the initialization step S101 of the various components is executed. More specifically, the blades on the transport path 74 are moved to the respective initial positions thereof as a mechanical initialization process. Additionally, the transport rollers on the path 74 are idly rotated for a predetermined time.

When the cash processor 10 is initialized, paper powder may be detected to be deposited on at least one of the locations at which the optical sensors 76a-76j are installed. Similarly, paper flakes may remain on a location at which a sensor 76 is installed. In those cases, the amount of light received by the phototransistor 80 reduces, so that it may erroneously be determined on the basis of the emitter current value of the phototransistor 80 of that sensor 76 that a bill stays on the transport path 76. When a bill is erroneously detected as such, the controller 20 rotates the transport rollers on the path 74 by a predetermined amount. If this rotation causes no change on the outputs from all the optical sensors 76a-76j, the initialization processes are then completed.

When any of the optical sensors 76a-76j senses a variation in light volume during the rotation of the transport rollers, the controller 20 interrupts the rotation and assumes that a bill remains in the bill processor 16. Next, the transport operation is carried out to transport the remaining bill thus assumed, or virtual bill, into the bill slot 62 to discharge the bill out. The initialization process is thus ended.

Then, the sensor controller 98 instructs the LED energizer 104 to maintain all the LEDs 78 of the optical sensors 76a-76j lit up. The sensor controller 98 also instructs the light amount detector 106 to detect the light amount from the emitter current values of the phototransistors 80. At this point, the sensor controller 98 instructs the memory 28 to store the values of the levels of light amount emitted by the optical sensors 76a-76j.

The sensor controller 98 instructs the comparator 108 to compare the emitter current value of each phototransistor 80 with the reference output value stored in advance in the memory 28. On the basis of a result from the comparison, the sensor controller 98 makes a decision as to whether or not the emitter current value is within the tolerable range (step S102).

If the emitter current value is within the tolerable range, the check of the sensor light amount is ended. On the contrary, if the emitter current value is outside, in this case lower than, the tolerable range the tolerable range, the operation of the bill processor 16 goes to the next step S103.

If the emitter current value is outside the tolerable range of the reference output value, the sensor controller 98 instructs the light amount adjuster 110 to vary, in this case increase, the amount of electric power to each LED 78 in steps. That is, the emitter current value is brought to within the tolerable range of the reference output value by adjusting the amount of light to be emitted (step S103). Because the emitter current value is brought into coincidence with the reference output value, the light amount may be reduced rather than increased.

For example, when the reference level of the optical sensor 76b is level 3, if one emitter current value is determined to be at level 1 from the output value from its phototransistor 80 in spite of the fact that the sensor light emission level of that optical sensor 76b has already been set to level 7, the level is increased to level 3 preferably in stepwise. That is, the level is incremented by two. The sensor controller 98 thus makes an adjustment to increase the amount of electric power to be supplied such that level 7 is changed to level 9.

The sensor controller 98 gives an instruction to store setting conditions automatically adjusted into the memory 28. The values of sensor light emission level stored in advance in the memory 28 are thus updated to newly set values.

In step S104, the sensor controller 98 instructs the light amount detector 106 to execute again the checking of the sensor light amount with the set value adjusted at step S103. If the adjusted sensor light emission level is level 9, and further if the phototransistor 80 outputs a signal corresponding to the light amount of reference level 3, the operation of the bill processor 16 proceeds to the next step S105. However, if the phototransistor 80 outputs a signal corresponding to a light amount lower than reference level 3, the sensor controller 98 determines that the cash processor 10 is in an abnormal condition to make the bill processor 16 proceed to step S107.

The sensor controller 98 instructs the cleaning determiner 112 to make a decision as to whether or not the servicing of the optical sensor 76b is needed. When the LED 78 in the optical sensor 76b emits the light of the amount of level 9, the cleaning determiner 112 determines that servicing of the optical sensor 76b is needed. The sensor controller 98 then reads out information on a maintenance screen from the memory 28 to combine this screen information with the information on the position of the optical sensor 76b that needs to be serviced. In this embodiment shown in FIG. 6, the maintenance screen information 90a is combined with the positional information 90b and 90c on the optical sensor 76b.

At this time, for the optical sensors other than the optical sensor 76b, i.e. the optical sensors 76a and 76c-76j in this example, the setting conditions are similarly automatic adjusted. If at least one of the optical sensors 76a and 76c-76j emits the light which has its sensor light emission level equal to or higher than level 8, then the sensor controller 98 further combines the positional information on the defective optical sensor(s) with the maintenance screen information. By contrast, if the sensor controller 98 determines that the amount of electric power supplied to the respective LEDs 78 provides a sufficient allowance for the maximum rated value, the sensor controller 98 determines that no servicing is needed (step S105).

The sensor controller 98 instructs the LCD controller 114 and the status indicator controller 116 to display service instruction information on the display unit 18 to urge the service person to conduct servicing such as cleaning (step S106).

The LCD controller 114 makes the LCD 90 display the instruction information 90a, the positional information 90b and the contaminated sensor position 90c.

The status indicator controller 116 makes the status indicator 94 lit up. In the embodiment shown in FIG. 6, the red LED 94a emits red light. Even when a plurality of optical sensors 76 are determined to be soiled, only the LED 94a is lit up. When the button 90d is depressed for inputting an instruction for instructing a cleaning method to be displayed on the display unit 18, detailed information on a cleaning method is read out from the memory 28 and displayed on the LCD device 90.

Various cleaning methods in the bill processor 16 can be arbitrarily adopted. For instance, when the sensor cleaning mode is activated by the operation of the mode switcher 38, a cleaning medium for use in cleaning the transport path 74 is taken in and transported over the path 74 to remove paper powder and bill flakes out of the cash processor 10.

Through the above operation, the initialization process is terminated. Thus, the cash processor 10 has been brought into its normal operation to be enabled. More specifically, even when service instruction information 90a as shown in FIG. 6 is displayed, the controller 20 is ready to be responsive to the check button 92a of the input unit 92 being depressed to control the cash processor 10 so as to automatically shift itself to the normal operation mode. During the normal operation also, the status indicator 94 is kept lit up.

In step S104, if the controller 20 fails to confirm the amount of light as reference level 3, it determines that the cash processor 10 is unable to normally function and then closes the initialization process as abnormal (step S107).

Next, alternative embodiments of the relationship between the level of amount of light to be emitted by the sensor 76 and a notice or indication depending on the level of light amount will be described below.

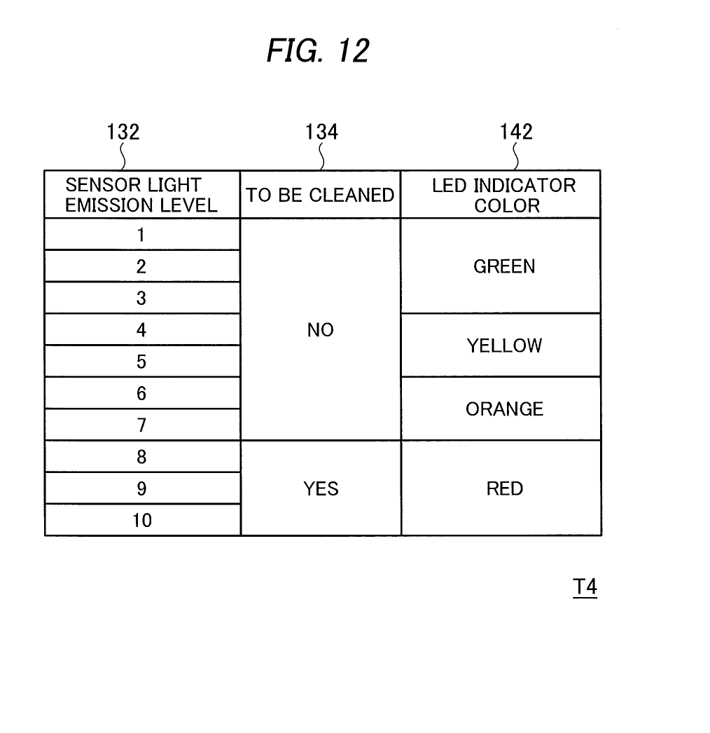

As the sensor light emission level 132 increases, the brightness of the light emitted by the status indicator 94, such as the red LED 94a that is a visible light illuminant, increases accordingly. The relationship between the sensor light emission level 132 and the brightness 138 of the status indicator 94 is defined on a table T2 shown in FIG. 10. In this embodiment, the normal brightness of the status indicator 94 is set to the reference level 4.

The LED 94a is configured not to be lit up until the amount of light emitted by the sensor 76 reaches the reference level 3. When the sensor light emission level 132 increases higher than the reference level 3, the brightness of the light emitted by the LED 94a also increases according to the sensor light emission level 132. In the table T2, the brightness of the LED 94a at reference level 8 or higher is doubled from the normal brightness of the emitting LED 94a. Thus, when the bill processor 16 need be cleaned, the brightness of the LED 94a increases by 100% compared to its normal brightness at reference level 4. In this way, a notice of the degree of urgency defining the necessity of servicing an optical sensor 76 can be produced as visual information.

The LED 94a, a visible light illuminant, may be adapted such that, as the sensor light emission level 132 increases, it blinks on and off at shorter intervals according to the sensor light emission level 132. The relationship between the sensor light emission level 132 and an emission interval 140 of the status indicator 94 is shown on a table T3 in FIG. 11.

As shown in this table T3, because the status indicator 94 is not turned on up to the reference level 3 nor the LED 94a blinks, the status indicator 94 is unlit. When the sensor light emission level 132 increases higher than reference level 3, the LED 94a blinks at shorter intervals according to the sensor light emission level 132 to thereby inform the user of a chance of cleaning. In the table T3, at light emission level 8, an emission duration of 50 ms is enabled at intervals of 2 seconds to inform the user that the urgency of requiring cleaning. In this way, a notice or indication of the degree of urgency defining the necessity of servicing an optical sensor 76 may be represented by the blinking interval. This provides an advantage that servicing may be prepared in advance.

The status indicator 94, a visible light illuminant, may alternatively or additionally be adapted such that, as the sensor light emission level 132 increases, it may change the color of the light emitted therefrom according to the sensor light emission level 132. The relationship between the sensor light emission level 132 and an indication color 142 of the status indicator 94 may be defined on a table T4 shown in FIG. 12.

In this embodiment of the table T4, as the status indicator 94, a type of LED which can provide multicolor emission is available. For example, when red light is emitted, the sensor light emission level 132 is at level 8 or higher. This notification of red light emission advantageously indicates that immediate servicing is necessitated.

Alternatively, the status indicator 94 may be configured to include the red, orange, yellow and green LEDs 94a, 94b, 94c and 94d, as shown in FIG. 6. In this constitution, during normal operation, the greed LED 94d is kept lit up. When it is likely that the optical sensor 76 will need to be serviced in the near future due to sensor contamination, the LED 94b or 94c is lit up or blinks. The red LED 94a may be adapted to be lit up or blink in the case that the rapid cleaning is needed, as previously described.

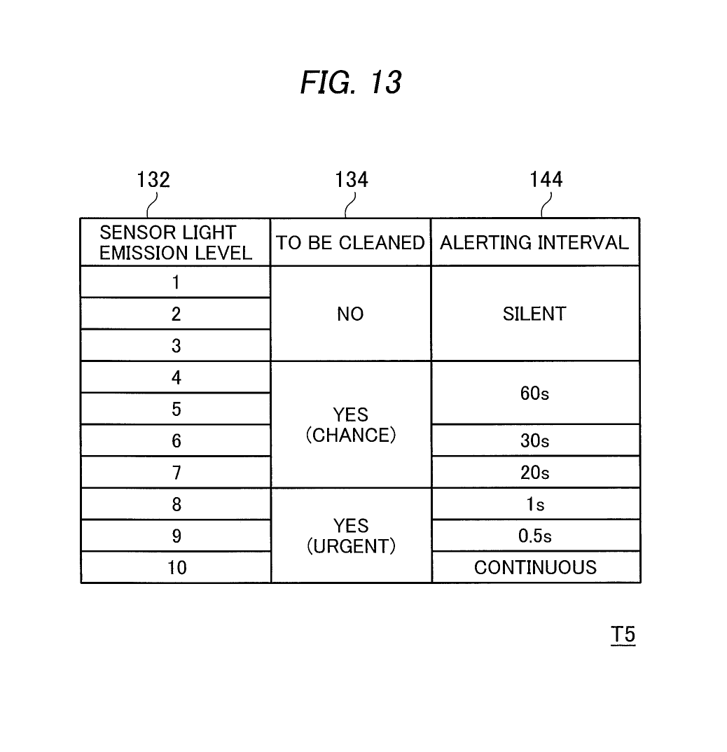

Alternatively or additionally to lighting of the status indicator 94, the loudspeaker 42 may be adapted so that, as the sensor light emission level 132 increases, it emits sound at shorter intervals according to the sensor light emission level 132. The relationship between the sensor light emission level 132 and an alerting interval 144 is shown on a table T5 in FIG. 13. The sensor controller 98 may be adapted to produce short-duration sound, e.g. beep, according to the sensor light emission level 132 to thereby develop an audible notice of auditory information. Obviously, such an audible notice may be used in combination with a visual warning described with reference to the tables T1-T4.

In summary, during the initialization, the checking and automatic adjustment of the light emission levels of the optical sensors 76 can be carried out. The operator may just clean only at least an optical sensor 76 indicated as contaminated on the display, such as the sensor 94c. When the initialization has been performed again, it can be determined that the servicing has been successful unless the status indicator 94 is lit up. Thus, the cash processor 10 can be of an improved convenience in use for the operator.

Next, an alternative embodiment of the present invention will be described. The embodiment described above is adapted so that the status indicator 94, once lit up in the initialization process, is kept lit up until the next initialization. However, in practice, bills handled during the normal operation may automatically remove paper powder or bill flakes. In an alternative embodiment, when an optical sensor 76 is detected as contaminated for the first time, the status indicator 94 is not lit up. When the contamination is detected repeatedly a predetermined number of times, the service instruction information is displayed as shown in FIG. 6.

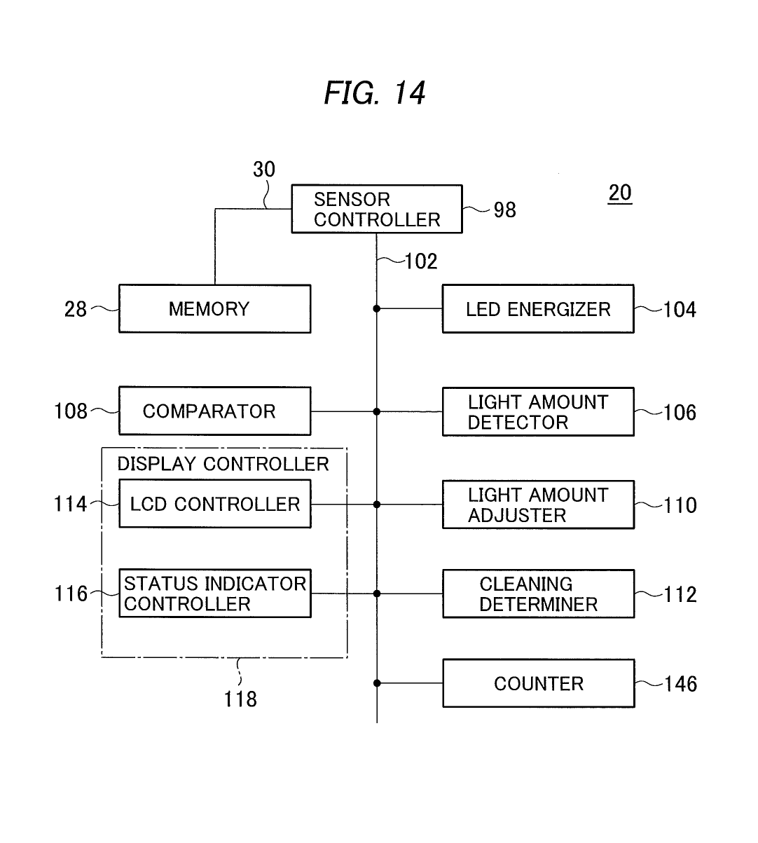

With reference to FIG. 14, a schematic functional block diagram of the controller 20, an alternative embodiment will be described which includes a counter 146 in the controller 20. In the alternative embodiment, the counter 146 is adapted to increment by one, under the control of the sensor controller 98, whenever the cleaning determiner 112 determines that the transport path 74 is needed to be cleaned.

More specifically, the counter 146 is adapted for counting the number of times that a sensor 76 to be cleaned is detected. On the basis of the count, the controller 20 determines whether or not the bill processor 16 need be serviced. For example, the counter 146 is adapted to increment when the contamination of a sensor 76 is successively detected and otherwise to be reset to its initial value, e.g. null, so that the total count having reached a predetermined value, e.g. two, causes service instruction information to be displayed on the display unit 18. The structure of the cash processor 10 of the alternative embodiment may essentially be similar to that of the illustrative embodiment described earlier. Thus, in FIG. 14, the constituent elements like those of the previous embodiment are designated with the same reference numerals to refrain from repetitive description thereon. The counter 146 may be included in the memory 28.

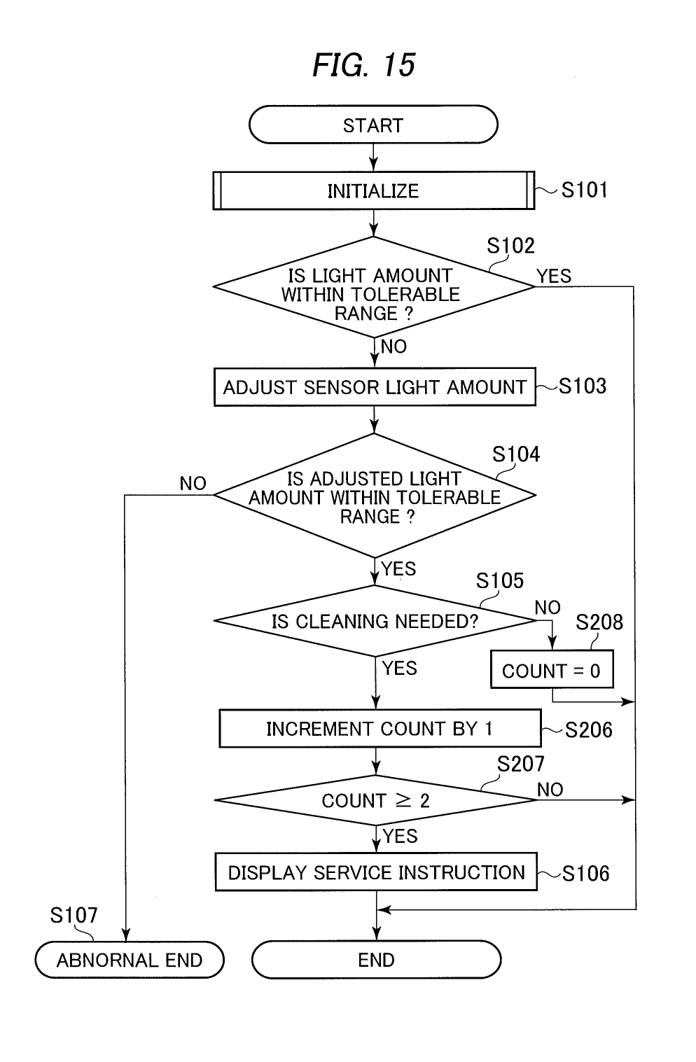

FIG. 15 is a flowchart illustrating the operation of the cash processor 10 with the alternative embodiment. When the power supply of the cash processor 10 is turned on, steps S101-S105 are performed, as with the pervious embodiment.

In step S105, at the time when the cleaning determiner 112 determines that the optical sensor 76 needs to be serviced, service information for prompting the operator to conduct an early cleaning work is not displayed on the display unit 18. Thus, the operator can determine that the cash processor 10 is in its normal condition.

The sensor controller 98 instructs the counter 112 to increment its total count by one (step S206). The sensor controller 98 subsequently makes a decision as to whether or not the incremented total count of the counter 146 has reached the predetermined value. For example, in step S207, if the relationship of the total count (of counter 146)≧2 holds, then the control operation proceeds to step S106. If the relationship of the total count (of counter 146)=1 holds, then the initialization is terminated. That is, the normal operation of the cash processor 10 will be enabled.

The sensor controller 98 lights up the state indicator 94 and reads out maintenance screen information from the memory 28 to combine therewith information on the position of an optical sensor 76 that needs to be serviced. The controller 20 controls the synthesized image information to be display as instruction information prompting the user to call for servicing, e.g. cleaning, on the display unit 18 (step S106).

If the determination at step S205 is that the amount of electric power fed to the LEDs 78 provides a sufficient allowance for the maximum rated value, in other words, the sensor controller 98 has determined that the optical sensor 76 does not need to be serviced, then the sensor controller 98 instructs the counter 146 to clear its total count to zero. The sensor controller 98 further instructs the memory 28 to store the updated count of the counter 146 (step S208).

In step S104, if the amount of light cannot be confirmed at reference level 3, the controller 20 determines that the cash processor 10 is unable to normally function and then terminates the initialization as abnormal (step S107).

At step S207, the status indicator 94 may start blinking on and off at the instant once the total count of the counter 146 becomes equal to unity. Furthermore, when the total count of the counter 146 becomes equal to two or higher 2), the status indicator 94 may be switched from its one mode in which it blinks to its other mode in which it is kept lit up. That configuration allows the cash processor 10 to suggest to the user the possibility that the optical sensor 76 will need to be serviced. The cash processor 10 can provide the advantage that advance preparation for maintenance is possible.

The preferred embodiments of the present invention described so far are specifically directed to a change dispenser for use in a cash register in shops such as supermarkets and convenience stores to work as the cash processor 10 connected to the POS register 12. The present invention may not be restricted to the illustrative embodiments. It is obvious to those skilled in the art that the present invention may be applied to any types of apparatus that controls transportation of media such as sheet-like materials, other than bills, e.g. passenger tickets, airline tickets, admission tickets for various events, lottery, or any types of plastic or electronic cards.

As a manner for adjusting the amount of light to be emitted by the LEDs 78, the LEDs 78 may be driven to emit pulsed light. In that case, when the light amount should be increased, the pulse width is increased to extend the duration of emitting light. Conversely, when the light amount should be reduced, the pulse width is reduced to shorten the emission duration.

In the embodiments described above, the sensor light emission level 132 is classified into the ten levels. However, the invention may not be restricted to those embodiments. For example, the manner in which the light emitters of the status indicator 94 are lit up may include a variety of drives up to an analog manner in which the LEDs 78 may be driven according to the amount of electric power to be supplied thereto.

The entire disclosure of Japanese patent application No. 2012-131774 filed on Jun. 11, 2012, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What I claim is:

1. A medium processor for processing a medium, comprising:
a path transporting the medium to be processed in said medium processor;
a display displaying a processing status of the medium;
a sensor sensing the medium on said path, said sensor including a light-emitting device emitting light and a photosensitive device receiving the light emitted from said light-emitting device to produce a signal associated with the light received; and
a controller controlling an operation of said medium processor to determine whether or not the medium is present on said path, said controller comprising:
a light amount detector detecting from the signal an amount of the light that said photosensitive device receives upon startup of said medium processor;
a comparator comparing the amount of the light detected by said light amount detector with a predetermined reference value;
a light amount adjuster adjusting an amount of electric power to be supplied to said light-emitting device to vary, when said comparator determines that the amount of the light is outside a tolerable range with respect to the predetermined reference value, the amount of electric power below a maximum rated value of said light-emitting device;
a cleaning determiner determining that said sensor needs to be serviced when the amount of electric power supplied to said light-emitting device is close to the maximum rated value under a condition where the amount of the light received by said photosensitive device is within the tolerable range of the reference value; and
a display controller controlling said display so that an indication of the need to service said sensor is displayed on said display when said cleaning determiner determines that said sensor needs to be serviced.

2. The medium processor in accordance with claim 1, wherein said light amount adjuster adjusts the amount of electric power in steps.

3. The medium processor in accordance with claim 2, further comprising a counter counting a frequency that said sensor is determined to be serviced, wherein
when said cleaning determiner determines that said sensor needs to be serviced, said controller controls said counter to increment a count value in said counter;
when said cleaning determiner determines that said sensor need not be serviced, said controller controls said counter to clear the count value in said counter; and
when an incremented count value in said counter reaches a predetermined value, said display controller controls said display to display an indication for prompting the servicing of said sensor on said display.

4. The medium processor in accordance with claim 2, wherein said display comprises a status indicator emitting visible light; and
said display controller controls the amount of electric power to be supplied to said status indicator in steps to control a brightness of a visible emission of said status indicator, the indication of the need to service said sensor being representative of a degree of the need to be displayed on said status indicator by the brightness.

5. The medium processor in accordance with claim 1, wherein said display comprises a status indicator emitting visible light; and
said display controller controls the amount of electric power to be supplied to said status indicator to control an interval of a visible emission of said status indicator, the indication of the need to service said sensor being representative of a degree of the need to be displayed on said status indicator by the interval.

6. The medium processor in accordance with claim 1, wherein said display comprises a status indicator emitting visible light; and
said display controller controls the amount of electric power to be supplied to said status indicator to control a color of a visible emission of said status indicator, the indication of the need to service said sensor being representative of a degree of the need to be displayed on said status indicator according to the color.

7. The medium processor in accordance with claim 1, further comprising a loudspeaker emitting an audible sound, wherein said controller controls said loudspeaker to control the sound when the indication of the need to service said sensor is displayed on said display.
